(19) United States
(12) Patent Application Publication
(10) Pub. No.: US 2019/0129921 A1
(43) Pub. Date: May 2, 2019

(54) Enhancing Crossing Copying and Pasting Operations

(71) Applicant: International Business Machines Corporation, Armonk, NY (US)

(72) Inventors: Jeffrey A. Calcaterra, Chapel Hill, NC (US); Zhi Li Guan, Beijing (CN); Su Liu, Austin, TX (US); Fang Wang, Austin, TX (US)

(21) Appl. No.: 15/800,288

(22) Filed: Nov. 1, 2017

(51) Int. Cl. G06F 17/21; G06K 9/00; G06F 17/24; G06K 9/20

(52) U.S. Cl. CPC G06F 17/211; G06K 9/00463; G06F 3/04842; G06K 9/00456; G06K 9/2081; G06F 17/243

(57) ABSTRACT

A mechanism is provided for enhancing crossing copying and pasting operations. A user selected area in a source document is captured as an image. A set of MIOUs within the image are identified and, for each MIOU, a set of coordinates is determined. A set of relationships between the MIOUs is generated. Optical character recognition (OCR) is performed on an object within each MIOU. Responsive to the OCR on the object within the MIOU identifying text within the MIOU, the object is converted to text thereby forming a converted MIOU. Responsive to the OCR on the object within the MIOU failing to identifying text within the MIOU, the object is marked as an image thereby forming an unconverted MIOU. One or more properties are determined for each MIOU, which are then assigned to the MIOU. Each converted MIOU and each unconverted MIOU are then rendered in a target document.

### BACKGROUND

The present application relates generally to an improved data processing apparatus and method and more specifically to mechanisms for enhancing crossing copying and pasting operations.

Word processors and rich text editors, such as Microsoft® Office®, Google Docs™, Apache OpenOffice™, Adobe® reader, Adobe® editor, or the like, are indispensable tools on daily documentation tasks. Some of the word processors and rich text editors support crossing editor copy/paste operation. For instance, Microsoft® Office® applications support a “paste special” feature that is a hardcoded format so a user may copy/paste content across all Microsoft® Office® products. As another example, the operation of “embedding documents” is another way to “paste” an object into a new editor. The demand for copying and pasting a text and image mixed section crossing different editors are increasing. Some word processors and rich text editor vendors already provide the capability to retain source layout reserved between copy and paste actions. For example, optical character recognition (OCR) is the mechanical or electronic conversion of images of typed, handwritten or printed text into machine-encoded text, whether from a scanned document, a photo of a document, a scene-photo (i.e. text on signs and billboards in a landscape photo) or from subtitle text superimposed on an image (i.e. a television broadcast). As another example, natural language processing (NLP) is a field of computer science, artificial intelligence, and computational linguistics concerned with the interactions between computers and human (natural) languages. As such, NLP is related to the area of human-computer interaction.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for enhancing crossing copying and pasting operations. The illustrative embodiment captures a user selected area in a source document of a source application as an image. The illustrative embodiment identifies a set of minimum image object units (MIOUs) within the image of the user selected area. for each MIOU in the set of MIOUs, the illustrative embodiment determines a set of coordinates for each corner of four corners that constitute the MIOU in relation to a position of the MIOU within the source document, thereby forming a rectangle. The illustrative embodiment generates a set of relationships between the MIOUs in the set of MIOUs based on the determined coordinates associated with each MIOU. The illustrative embodiment performs optical character recognition (OCR) on an object within the MIOU in the set of MIOUs such that, responsive to the OCR on the object within the MIOU identifying text within the MIOU, the illustrative embodiment converting the object within the MIOU to text thereby forming a converted MIOU and, responsive to the OCR on the object within the MIOU failing to identifying text within the MIOU, the illustrative embodiment marks the object within the MIOU as an image thereby forming an unconverted MIOU. The illustrative embodiment determines one or more properties for each MIOU in the set of MIOUs and assigns the one or more properties determined for each MIOU to the associated MIOU. The illustrative embodiment renders each converted MIOU and each unconverted MIOU in a target document in a target application utilizing the one or more properties associated with to the MIOU, the set of coordinates associated with to the MIOU, and the set of relationships.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a functional block diagram of a mechanism for enhancing crossing copying and pasting operations in accordance with an illustrative embodiment; and

FIG. 4 depicts an exemplary flow diagram of the operation performed by an enhanced copy/paste mechanism in accordance with an illustrative embodiment.

### DETAILED DESCRIPTION

The illustrative embodiments provide mechanisms for enhancing crossing copying and pasting operations. As noted previously, word processors and rich text editors are indispensable tools on daily documentation tasks. Some of the word processors and rich text editors support crossing editor copy/paste operation, such as a “paste special” feature that provides for copying and/or pasting content across various products, or an “embedding documents” feature that provides for “pasting” an object into a new editor. However, some “paste special” features may cause bizarre conversions in the pasting of the original text/image to the destination location as well as some “embedding documents” features creating dependencies and requiring other application to edit the final text/image.

Current solutions to reduce the issues cause by such features include the “keep source formatting” feature. For instance, the “keep source formatting” paste feature on certain text document processor paste text content from another document processor or from a web browser. In the “keep source formatting” paste feature, the original format control information (font type and color, paragraph separators, or the like) may be reserved during the copy/paste operation, but there is no guarantee that the “keep source formatting” paste feature will works on any rich text document editors due to limitations of different standards (format tag, control symbols, or the like). More issues arise in copy/paste operations when combined text and image content is to be copied and pasted from another document processor or from a web browser. That is, the image may not be copied due to unmatched layout rules. Therefore, there is an issue when text and/or images are to be copied and pasted to text editors because all original format control information (font type and color, paragraph separators, or the like) may not be pasted or pasted improperly.

Thus, the illustrative embodiments provide for an enhanced copy/paste mechanism that retains the original layout during copy/paste operations crossing two word processor/rich text editor systems. The enhanced copy/paste mechanism replicates an existing layout of a document in one format to a document in another format by analyzing the existing layout. To do this, the enhanced copy/paste mechanism captures the selected copying area as an image from the source document viewer and identifies a set of minimum image object units (MIOUs) in the selected copying area. For each MIOU, the enhanced copy/paste mechanism determines a set coordinates associated with the corners of the MIOU thereby forming a rectangle. The enhanced copy/paste mechanism builds a relationship of each identified object and attempts to convert text within the MIOU from the source format to the target format. If the text within the MIOU is able to be converted, then the enhanced copy/paste mechanism pastes the text in the target format. If subsequent MIOUs have text that is convertible from the source format to the target format, the enhanced copy/paste mechanism merges the converted text units into text string. For the text object or text object string the enhanced copy/paste mechanism determines font/format/style properties to each of text objects, such as font style, size, font color, line break, paragraph separator, line space for the unconvertable MIOU. The enhanced copy/paste mechanism assigns the determined font/format/style properties to each MIOU. If the text within the MIOU is unconvertable, the enhanced copy/paste mechanism recreates the MIOU as an image. The enhanced copy/paste mechanism then renders the converted MIOUs and the unconverted MIOUs in the target document viewer based on the determined set of coordinates associated with each MIOU.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

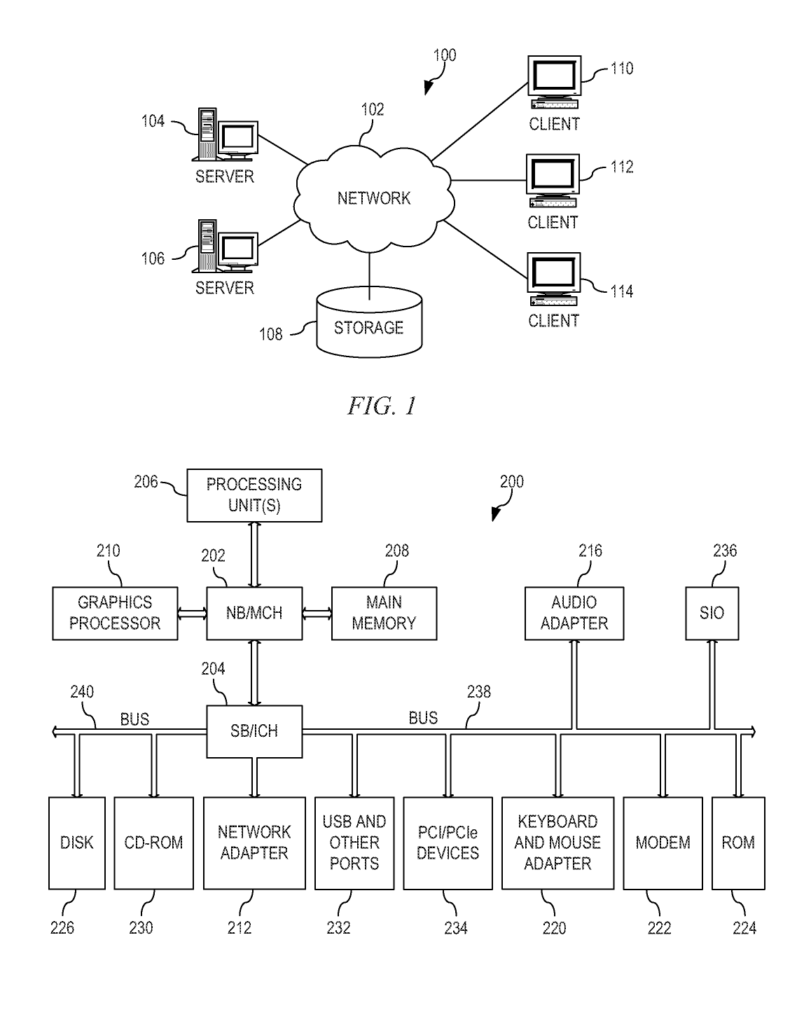

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104, may be specifically configured to implement an enhanced copy/paste mechanism. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates enhancing crossing copying and pasting operations.

As noted above, the mechanisms of the illustrative embodiments utilize specifically configured computing devices, or data processing systems, to perform the operations for enhances crossing copying and pasting operations. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external effects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PC uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to enhancing crossing copying and pasting operations.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

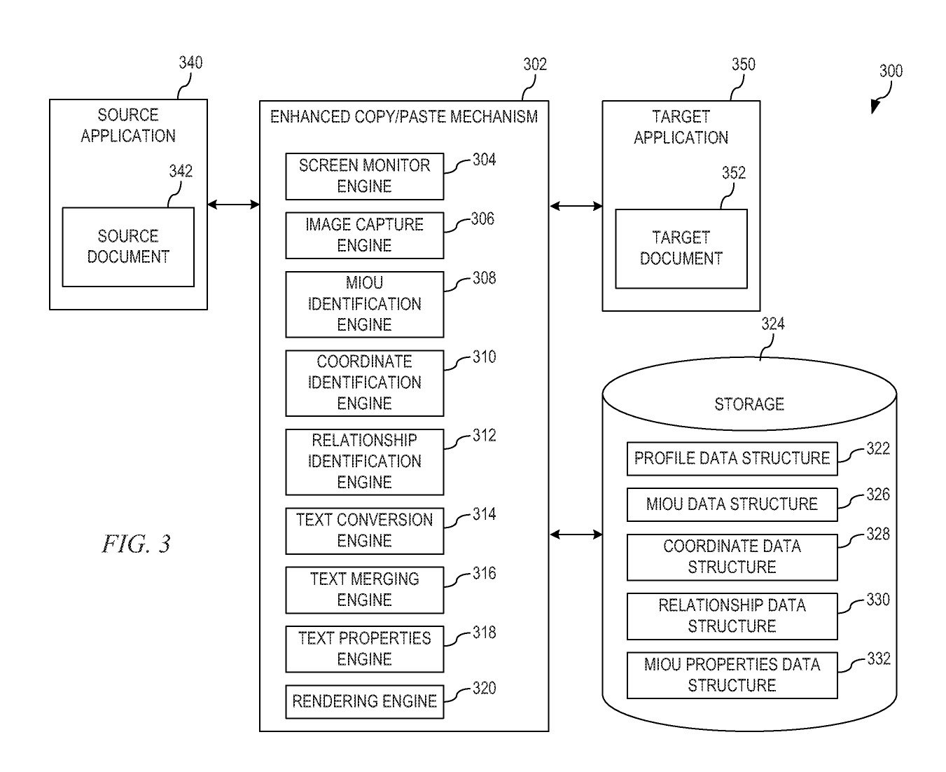

FIG. 3 depicts a functional block diagram of a mechanism for enhancing crossing copying and pasting operations in accordance with an illustrative embodiment. Data processing system 300 comprises enhanced copy/paste mechanism 302 which may reside between source application 340 and target application 350, within source application 340, within target application 350, or within both source application 340 and target application 350 and working in conjunction with one another. Enhanced copy/paste mechanism 302 comprises screen monitor engine 304, image capture engine 306, minimum image object unit (MIOU) identification engine 308, coordinate identification engine 310, relationship identification engine 312, text conversion engine 314, text merging engine 316, text properties engine 318, and rendering engine 320. In order to enhance crossing copying and pasting operations, screen monitoring engine 302 monitors for a selection of a portion of text and/or an image within source document 342 in source application 340. That is, as a user utilizes a mouse, keyboard, or other peripheral device to select a portion of text and/or an image within source document 342 of the source application 340, screen monitoring engine 302 identifies the user's selection of the portion of text and/or the image as a potential copy area. Screen monitoring engine 302 then monitors for the execution of an operation or feature to copy the user selected area, such as through the identification of a “Control C” command through a keyboard, a selection of a “Copy” icon by the mouse, or the like.

Once screen monitoring engine 302 identifies the selection of the portion of text and/or the image of source document 342 as a potential copy area and the execution of an operation or feature to copy the user selected area, screen monitoring engine 302 triggers image capture engine 306 to capture the user selected area as an image, that may include only text, only an image, or both text and an image. Image captures engine 306 captures the user selected area as an image and sends the image to MIOU identification engine 308. MIOU identification engine 308 identifies a set of minimum image object units u within the image of the user selected area U identified as: U[u₁, u₂, u₃, u₄, . . . , uₙ]. That is, minimum image object units u₁, u₂, u₃, u₄, . . . , uₙ are the minimum image object units (MIOUs) within user selected area U that are identified as individual text portions and/or images. Each MIOU may comprise a word, an image, or even just a single character. MIOU identification engine 308 identifies the individual text portions and/or images using a predetermined object identification profile stored in a profile data structure 322, for example, optical character recognition (OCR), natural language processing (NLP), or the like. MIOU identification engine 308 stores each of the identified MIOUs in MIOU data structure 326 of storage 324.

For each identified MIOU uₖ, coordinate identification engine 310 determines set coordinates of each corner of the MIOU in relation to the MIOU's position within source document 342, thereby forming a rectangle with coordinates uₖ[(x1, y1), (x1, y1+i) (x1+i, y1) (x1+i, y1+i)]. Coordinate identification engine 310 stores each of the coordinates for each MIOU in coordinate data structure 328 of storage 324. Relationship identification engine 312 then generates a relationship between the MIOUs based on the identified MIOU coordinates associated with the MIOUs identified within source document 342. By generating the relationship between the MIOUs within source document 342, enhanced copy/paste mechanism 302 will be able to recreate each MIOU of the user selected area in a location relative to the location of other MIOUs within source document 342. Relationship identification engine 312 stores the identified relationships in a relationship data structure 330 within storage 324.

For each identified MIOU uₖ in MIOU data structure 326 of storage 324, text conversion engine 314 then attempts to convert each MIOU to text using the predetermined object identification profile stored in a server profile data structure 322, for example, optical character recognition (OCR), natural language processing (NLP), or the like, such that uₖ→tₖ. If text conversion engine 314 is unable to convert the MIOU to text, text conversion engine 314 marks the MIOU as unconvertable. That is, the MIOU may comprise an image or a character that is unrecognizable by text conversion engine 314. If text conversion engine 314 is able to convert the MIOU to text, text conversion engine 314 determines whether the text conversion is accurate. That is, if optical character recognition (OCR) is performed on the MIOU of “Niagara Falls” and the OCR fails to identify a portion of either word such as, for example, the OCR results in a text conversion of “Nagara Falls” and misses the “i”, then text conversion engine 314 may execute natural language processing (NLP) to identify the missing “i” and correct the text conversion to read “Niagara Falls.” Thus, the NLP portion of the text conversion makes corrections to incorrect text conversions based on context that surround the incorrect text conversions.

Additionally, if text conversion engine 314 converts two or more consecutive MIOUs, uₖ, uₖ₊₁, . . . , uₖ₊ₙ to text tₖ, tₖ₊₁, . . . , tₖ₊ₙ, text merging engine 316 merges the converted text within the MIOU into a merged set of MIOUs, i.e. a text string t_{k→k+n}. For any merged set MIOUs, coordinate identification engine 310 utilizes the associated coordinate information in coordinate data structure 328 and the relationship information in relationship data structure 330 within storage 324 to merge the determined coordinates for each MIOU associated with the merged set of MIOUs thereby forming a longer rectangle.

For each converted MIOU or merged set of MIOUs, text properties engine 318 determines one or more properties such as a font, format, style, or the like, for each MIOU or merged set of MIOUs. Text properties engine 318 determines the one or more properties based on format, layout, or the like, of target document 352 in target application 350 or based on format, layout, or the like, of source document 342 in source application 340 if the user indicates that the original layout is to be reserved. The style properties may include, for example, font style, size, font color, line break, paragraph separator, line space, or the like. Text properties engine 318 stores the determined properties in a MIOU properties data structure 332 in storage 324. Text properties engine 318 then assigns the determined properties for each MIOU or merged set of MIOUs to the associated MIOU or merged set of MIOUs. Therefore, when the user pastes the user selected area in target document 352 of target application 350, rendering engine 320 render the converted MIOUs and unconvertible MIOUs in target document 352. For example, if the original MIOUs are u₁, u₂, u₃, u₄, u₅, u₆, u₇, u₈ and all but MIOU u₆, then rendering engine 320 would upset the determination described previously to render u₁, u₂, u₃, u₄, u₅, u₆, u₇, u₈ as t₁, t₂, t₃, t₄, t₅, u₆, t₇, t₈.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

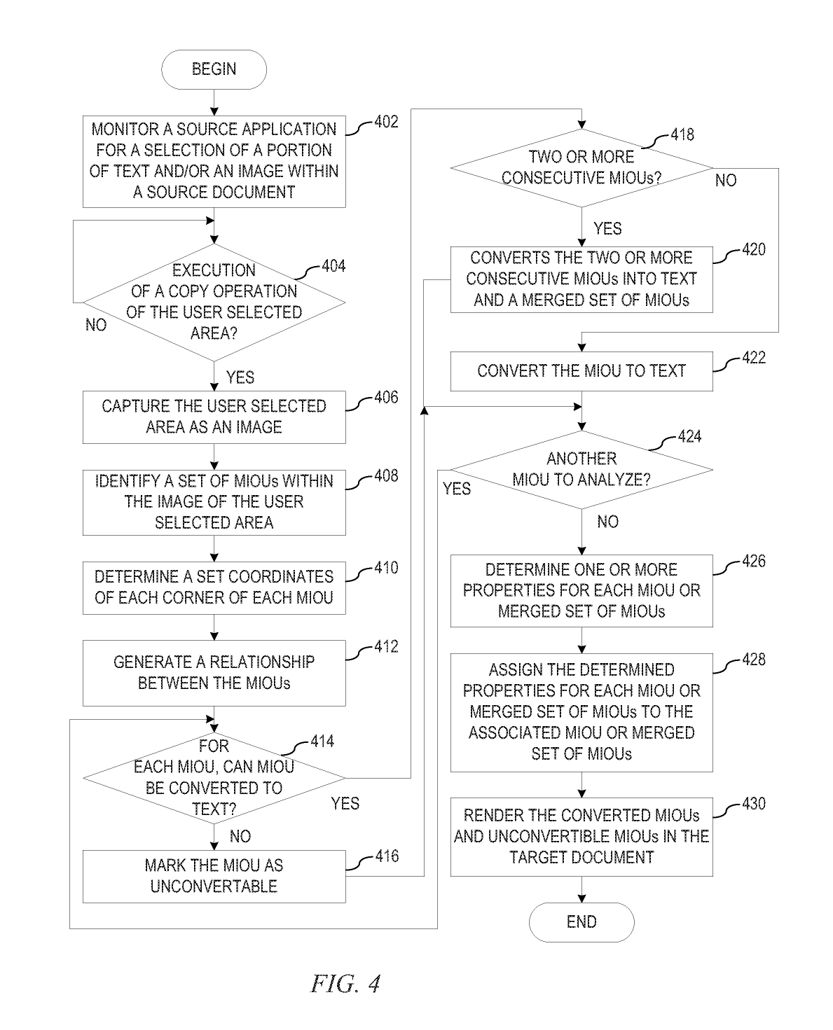

FIG. 4 depicts an exemplary flow diagram of the operation performed by an enhanced copy/paste mechanism in accordance with an illustrative embodiment. As the operation begins, the enhanced copy/paste mechanism monitors a source application for a user selected portion of text and/or an image within a source document in the source application (step 402). The enhanced copy/paste mechanism then monitors for the execution of an operation or feature to copy the user selected area (step 404). If at step 404 the user does not execute the operation or feature to copy the user selected area, then the operation returns to step 404.

If at step 404 the user executes the operation or feature to copy the user selected area, the enhanced copy/paste mechanism captures the user selected area as an image (step 406). The user selected are may include only text, only an image, or both text and an image. The enhanced copy/paste mechanism then identifies a set of minimum image object units (MIOUs) within the image of the user selected area (step 408), which are stored in an MIOU data structure. For each identified MIOU, the enhanced copy/paste mechanism determines a set coordinates of each corner of the MIOU in relation to the MIOU's position within the source document, thereby forming a rectangle (step 410), which are stored in a coordinate data structure. The enhanced copy/paste mechanism then generates a relationship between the MIOUs (step 412) based on the identified MIOU coordinates associated with the MIOUs identified within the source document, which is stored in a relationship data structure. By generating the relationship between the MIOUs within the source document, the enhanced copy/paste mechanism will be able to recreate each MIOU of the user selected area in a location relative to the location of other MIOUs within the source document.

For each identified MIOU in the MIOU data structure, the enhanced copy/paste mechanism attempts to convert each MIOU to text using the predetermined object identification profile stored in a server profile data structure (step 414). If at step 414 the enhanced copy/paste mechanism is unable to convert the MIOU to text, the enhanced copy/paste mechanism marks the MIOU as unconvertable (step 416). If at step 414 the enhanced copy/paste mechanism is able to convert the MIOU to text, the enhanced copy/paste mechanism determines whether two or more consecutive MIOUs have been converted (step 418). If at step 418 two or more consecutive MIOUs have been converted, the enhanced copy/paste mechanism converts the two or more consecutive MIOUs into text and a merged set of MIOUs, i.e. a text string t_{k→k+n} (step 420). That is, the enhanced copy/paste mechanism utilizes the associated coordinate information in the coordinate data structure and the relationship information in the relationship data structure to merge the determined coordinates for each MIOU associated with the merged set of MIOUs thereby forming a longer rectangle. If at step 418 two or more consecutive MIOUs fail to have been converted, the enhanced copy/paste mechanism converts the MIOU to text (step 422). From steps 416, 420, and 422, the enhanced copy/paste mechanism determines whether these are another MIOU to analyze (step 424). If at step 424 there is another MIOU, the operation returns to step 414.

If at step 424 there is not another MIOU to analyze, the enhanced copy/paste mechanism determines one or more properties for each MIOU or merged set of MIOUs (step 426). The enhanced copy/paste mechanism determines the one or more properties based on a format, layout, or the like, of the target document in the target application or based on a format, layout, or the like, of the source document in the source application if the user indicates that the original layout is to be reserved. The enhanced copy/paste mechanism then assigns the determined properties for each MIOU or merged set of MIOUs to the associated MIOU or merged set of MIOUs (step 428). The enhanced copy/paste mechanism then renders the converted MIOUs and unconvertible MIOUs in the target document (step 430), with the operation terminating thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for an enhanced copy/paste mechanism that retains the original layout during copy/paste operations. The enhanced copy/paste mechanism replicates an existing layout of a document in one format to a document in another format by analyzing the existing layout. The enhanced copy/paste mechanism captures the selected copying area as an image from the source document viewer and identifies a set of minimum image object units (MIOUs) in the selected copying area. For each MIOU, the enhanced copy/paste mechanism determines a set coordinates associated with the corners of the MIOU thereby forming a rectangle. The enhanced copy/paste mechanism builds a relationship of each identified object and attempts to convert text within the MIOU from the source format to the target format. If the text within the MIOU is unconvertable, the enhanced copy/paste mechanism recreates the MIOU as an image. If the text within the MIOU is able to be converted, then the enhanced copy/paste mechanism pastes the text in the target format. For the text object or text object string the enhanced copy/paste mechanism determines font/format/style properties to each of text objects, such as font style, size, font color, line break, paragraph separator, line space for the unconvertable MIOU. The enhanced copy/paste mechanism assigns the determined font/format/style properties to each MIOU. The enhanced copy/paste mechanism then renders the converted MIOUs and the unconverted MIOUs in the target document viewer based on the determined set of coordinates associated with each MIOU.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method, in a data processing system comprising at least one processor and at least one memory, the at least one memory comprising instructions executed by the at least one processor to cause the at least one processor to enhance crossing copying and pasting operations, the method comprising:
capturing a user selected area in a source document of a source application as an image;
identifying a set of minimum image object units (MIOUs) within the image of the user selected area;
for each MIOU in the set of MIOUs, determining a set of coordinates for each corner of four corners that constitute the MIOU in relation to a position of the MIOU within the source document, thereby-forming a rectangle;
generating a set of relationships between the MIOUs in the set of MIOUs based on the determined coordinates associated with each MIOU;
performing optical character recognition (OCR) on an object within the MIOU in the set of MIOUs by:
responsive to the OCR on the object within the MIOU identifying text within the MIOU, converting the object within the MIOU to text forming a converted MIOU and correcting any text errors by executing natural language processing (NLP) on the converted MIOU; and
responsive to the OCR on the object within the MIOU failing to identifying text within the MIOU, marking the object within the MIOU as an image forming an unconverted MIOU;
determining one or more properties for each MIOU in the set of MIOUs;
assigning the one or more properties determined for each MIOU to the associated MIOU; and
rendering each converted MIOU and each unconverted MIOU in a target document in a target application utilizing the one or more properties associated with to the MIOU, the set of coordinates associated with to the MIOU, and the set of relationships.

2. The method of claim 1, wherein the user selected ara includes text, an image, or both text and an image.

3. The method of claim 1, wherein each MIOU in the set of MIOUs comprises text, an image, or both text and an image.

4. The method of claim 1, wherein the source application and the target application are different applications.

5. The method of claim 1, wherein each converted MIOU and each unconverted MIOU are rendered in the target document in the target application based on a format or layout of the target document in the target application

6. The method of claim 1, wherein each converted MIOU and each unconverted MIOU are rendered in the target document in the target application based on a format or layout of the source document in the source application.

7. The method of claim 1, further comprising:
determining whether two or more consecutive MIOUs have been converted to text; and
responsive to two or more consecutive MIOUs being converted to text, merging the two or more consecutive MIOUs into a merged set of MIOUs utilizing the set of coordinates associated with to the MIOU and the set of relationships associated with the two or more consecutive MIOUs.

8. A computer program product comprising a computer readable storage medium having a computer readable program stored therein, wherein the computer readable program, when executed on a computing device, causes the computing device to:
capture a user selected area in a source document of a source application as an image;
identify a set of minimum image object units (MIOUs) within the image of the user selected area;
for each MIOU in the set of MIOUs, determine a set of coordinates for each corner of four corners that constitute the MIOU in relation to a position of the MIOU within the source document, forming a rectangle;
generate a set of relationships between the MIOUs in the set of MIOUs based on the determined coordinates associated with each MIOU;
perform optical character recognition (OCR) on an object within the MIOU in the set of MIOUs by:
responsive to the OCR on the object within the MIOU identifying text within the MIOU, convert the object within the MIOU to text forming a converted MIOU and correct any text errors by executing natural language processing (NLP) on the converted MIOU; and
responsive to the OCR on the object within the MIOU failing to identifying text within the MIOU, mark the object within the MIOU as an image forming an unconverted MIOU;
determine one or more properties for each MIOU in the set of MIOUs;
assign the one or more properties determined for each MIOU to the associated MIOU; and
render each converted MIOU and each unconverted MIOU in a target document in a target application utilizing the one or more properties associated with to the MIOU, the set of coordinates associated with to the MIOU, and the set of relationships.

9. The computer program product of claim 8, wherein the user selected area includes text, an image, or both text and an image.

10. The computer program product of claim 8, wherein each MIOU in the set of MIOUs comprises text, an image, or both text and an image.

11. The computer program product of claim 8, wherein the source application and the target application are different applications.

12. The computer program product of claim 8, wherein each converted MIOU and each unconverted MIOU are rendered in the target document in the target application based on a format or layout of the target document in the target application

13. The computer program product of claim 8, wherein each converted MIOU and each unconverted MIOU are rendered in the target document in the target application based on a format or layout of the source document in the source application.

14. The computer program product of claim 8, wherein the computer readable program further causes the computing device to:
determine whether two or more consecutive MIOUs have been converted to text; and
responsive to two or more consecutive MIOUs being converted to text, merge the two or more consecutive MIOUs into a merged set of MIOUs utilizing the set of coordinates associated with to the MIOU and the set of relationships associated with the two or more consecutive MIOUs.

15. An apparatus comprising:
a processor, and
a memory coupled to the processor, wherein the memory comprises instructions which, when executed by the processor, cause the processor to;
capture a user selected area in a source document of a source application as an image;
identify a set of minimum image object units (MIOUs) within the image of the user selected area;
for each MIOU in the set of MIOUs, determine a set of coordinates for each corner of four corners that constitute the MIOU in relation to a position of the MIOU within the source document, forming a rectangle;
generate a set of relationships between the MIOUs in the set of MIOUs based on the determined coordinates associated with each MIOU;
perform optical character recognition (OCR) on an object within the MIOU in the set of MIOUs by:
responsive to the OCR on the object within the MIOU identifying text within the MIOU, convert the object within the MIOU to text forming a converted MIOU and correct any text errors by executing natural language processing (NLP) on the converted MIOU; and
responsive to the OCR on the object within the MIOU failing to identifying text within the MIOU, mark the object within the MIOU as an image forming an unconverted MIOU;
determine one or more properties for each MIOU in the set of MIOUs;
assign the one or more properties determined for each MIOU to the associated MIOU; and
render each converted MIOU and each unconverted MIOU in a target document in a target application utilizing the one or more properties associated with to the MIOU, the set of coordinates associated with to the MIOU, and the set of relationships.

16. The apparatus of claim 15, wherein the user selected area includes text, an image, or both text and an image.

17. The apparatus of claim 15, wherein each MIOU in the set of MIOUs comprises text, an image, or both text and an image.

18. The apparatus of claim 15, wherein each converted MIOU and each unconverted MIOU are rendered in the target document in the target application based on a format or layout of the target document in the target application

19. The apparatus of claim 15, wherein each converted MIOU and each unconverted MIOU are rendered in the target document in the target application based on a format or layout of the source document in the source application.

20. The apparatus of claim 15, wherein the instructions program further cause the processor to:
determine whether two or more consecutive MIOUs have been converted to text; and
responsive to two or more consecutive MIOUs being converted to text, merge the two or more consecutive MIOUs into a merged set of MIOUs utilizing the set of coordinates associated with to the MIOU and the set of relationships associated with the two or more consecutive MIOUs.
